(19) United States
(12) Patent Application Publication
(10) Pub. No.: US 2026/0277587 A1
(43) Pub. Date: Sep. 17, 2026

(54) FIRMWARE UPDATING METHOD AND ELECTRONIC DEVICE, ELECTRONIC SYSTEM USING THE FIRMWARE UPDATING METHOD

(71) Applicant: PixArt Imaging Inc., Hsin-Chu City (TW)

(72) Inventors: Chien-Zhi Wang, Hsin-Chu City (TW); Jr-Yi Li, Hsin-Chu City (TW); Te-Wei Huang, Hsin-Chu City (TW)

(73) Assignee: PixArt Imaging Inc., Hsin-Chu City (TW)

(21) Appl. No.: 19/414,236

(22) Filed: Dec. 9, 2025

Related U.S. Application Data
(63) Continuation-in-part of application No. 19/082,146, filed on Mar. 17, 2025.

(51) Int. Cl. G06F 8/65; G06F 11/1446

(52) U.S. Cl. CPC G06F 8/65; G06F 11/1446

(57) ABSTRACT

A firmware updating method, applied to a host, comprising: the host transmitting a transmitting sequence for a sub device of a target device, wherein the transmitting sequence is for updating a firmware of the sub device; the host or the target device initiating a monitor procedure to identify whether transmission of the transmitting sequence is finished or interrupted; the host or the target device terminating the monitor procedure if the transmission is finished; and the monitor procedure providing a notice signal to the target device or the host if the transmission is interrupted. By this way, the host or the target device can be notified of the firmware update interrupting, and the host or the target device can operate correspondingly.

### CROSS REFERENCE TO RELATED APPLICATIONS

This application is a continuation-in-part of U.S. Application No. 19/082,146, filed on Mar. 17, 2025. The content of the application is incorporated herein by reference.

### BACKGROUND OF THE INVENTION

### 1. Field of the Invention

The present invention relates to a firmware updating method and an electronic device, an electronic system using the method, and particularly relates to a firmware updating method and an electronic device, an electronic system using the method which can determine whether updating of a firmware is interrupted or not.

### 2. DESCRIPTION OF THE PRIOR ART

Traditionally, a host always needs to update the firmware of various devices connected thereto. However, in some cases, if the updating is interrupted, the host and the device will not be aware that the update has not been completed. In this case, the device with firmware to be updated may not work properly or may not work at all, since the firmware updating is not completed or the firmware is corrupted.

### SUMMARY OF THE INVENTION

One objective of the present invention is to provide a firmware updating method which can detect the firmware update interrupting.

Another objective of the present invention is to provide a firmware updating method which can detect the firmware update interrupting.

One embodiment of the present invention discloses a firmware updating method, applied to a host, comprising: the host transmitting a transmitting sequence for a sub device of a target device, wherein the transmitting sequence is for updating a firmware of the sub device; the host or the target device initiating a monitor procedure to identify whether transmission of the transmitting sequence is finished or interrupted; the host or the target device terminating the monitor procedure if the transmission is finished; and the monitor procedure providing a notice signal to the target device or the host if the transmission is interrupted.

Another embodiment of the present invention discloses an electronic system, comprising: at least one storage device, configured to store at least one program; a host; a target device, comprising at least one sub device; a processing circuit, configured to execute the program to perform a firmware updating method comprising: following steps: the host transmitting a transmitting sequence for the sub device of a target device, wherein the transmitting sequence is for updating a firmware of the sub device; the host or the target device initiating a monitor procedure to identify whether transmission of the transmitting sequence is finished or interrupted; the host or the target device terminating the monitor procedure if the transmission is finished; and the monitor procedure providing a notice signal to the target device or the host if the transmission is interrupted.

In view of above-mentioned embodiments, the host or the target device can be notified of the firmware update interrupting, and the host or the target device can operate correspondingly. Thus, the issue of the conventional firmware updating method can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a firmware updating method according to one embodiment of the present invention.

FIG. 2 is a schematic diagram illustrating a progress bar of updating the firmware, according to one embodiment of the present invention.

FIG. 3 is a block diagram illustrating detail operations of updating the firmware, according to one embodiment of the present invention.

FIG. 4 is a block diagram illustrating detail structures of the first storage device in FIG. 3, according to one embodiment of the present invention.

FIG. 5 is a flow chart illustrating a firmware updating method, according to one embodiment of the present invention.

FIG. 6 is a block diagram illustrating a system using the firmware updating method, according to one embodiment of the present invention.

FIG. 7 is a flow chart illustrating a firmware updating method, according to one embodiment of the present invention.

FIGS. 8-12 are flow charts illustrating firmware updating method, according to different embodiments of the present invention.

### DETAILED DESCRIPTION

In the following descriptions, the term “first”, “second”, “third” are only for the purpose of distinguishing different one elements, and do not mean the sequence of the elements. For example, a first device and a second device only mean these devices can have the same structure but are different devices.

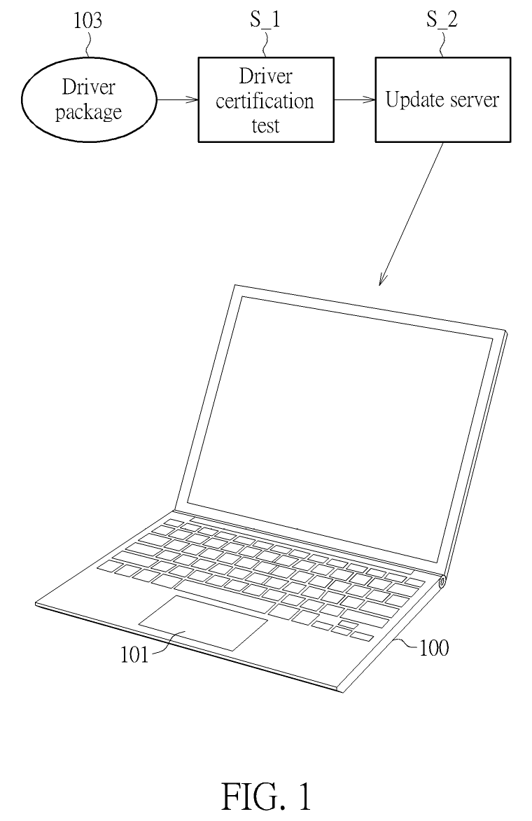

FIG. 1 is a schematic diagram illustrating a firmware updating method according to one embodiment of the present invention. In following embodiments, an electronic system comprising a laptop 100 and a touch pad 101 thereof are used as examples for explaining. However, the laptop 100 can be replaced by any other electronic device which serves as a host, and the touch pad 101 can be replaced by any other target device. Also, the target device is not limited to be provided inside the host.

In the embodiment of FIG. 1, a driver package 103 may be provided by a firmware source. For example, the driver package 103 may be provided by a manufacturer of the laptop 100 or a manufacturer of the touch pad 101. The driver package 103 may comprise the updating data of a firmware of the touch pad 101, or comprising a newest version of firmware. The driver package 103 may further comprise other software components, corresponding to the OS (operation system) which the laptop 100 uses. For example, the driver package 103 may comprise an on line updating application, a monitor application, a service file (ex. Windows service), a firmware binary file or an Inf file. The monitoring application can be used for the monitoring procedure described below.

Next, the driver package 103 is tested by a driver certification test S_1. The driver certification test S_1 may be provided by the OS manufacturer to ensure that the driver (firmware) of the touch pad 101 can run smoothly in the OS. For example, if the OS is Windows, the driver certification test S_1 may be HLK(Hardware Lab Kit) test. After the driver package 103 passes the driver certification test S_1, the laptop 101 can download the driver package 103 via the update server S_2. The update server S_2 may have different names and contents corresponding to the OS which the laptop 100 uses. For example, if the OS is Windows, the update server S_2 is a windows update server.

After downloading the driver package 103, the laptop 100 may start to update the firmware. The operation of “update the firmware” may mean installing the updating data to the firmware, or installing the newest version of the firmware. During updating the firmware, the laptop 101 may initiate a monitor procedure to monitor whether the operation of “update the firmware” is completed or not (i.e., succeed or failed). In one embodiment, the laptop 101 transmits a transmitting sequence for the touch pad 101, wherein the transmitting sequence is for updating the firmware of the touch pad 101. The transmitting sequence may mean a data sequence such as a bit sequence. Thus, the transmitting sequence may comprise data of the above-mentioned updating data, or data of the newest version of the firmware.

In such case, the laptop 100 initiates the above-mentioned monitor procedure to identify whether transmission of the transmitting sequence is finished or interrupted. The transmission of the transmitting sequence may mean, for example, the transmission to a storage device which stores the firmware of the touch pad 101. Details of the storage device will be described in following descriptions. The monitor procedure can be implemented by various software. For example, in one embodiment, the OS is Windows and the monitor procedure is a WMI (Windows Management Instrumentation). If the transmission is finished, which may represent the operation of “updating the firmware” is completed, the laptop 100 terminates the monitor procedure. On the opposite, if the transmission is interrupted, the monitor procedure provides a notice signal to the touch pad 101. In another embodiment, if the transmission is interrupted, the laptop 100 or the touch pad 101 may operate correspondingly. For example, if the transmission is interrupted, the laptop 100 or the touch pad 101 may reboot, or the process of updating the firmware may restart again.

Details of the operation of “update the firmware” will be described in following descriptions. In one embodiment, the firmware of the touch pad 101 is updated by a service of the OS. For example, if the OS is Windows, the laptop 100 launches the Windows service, which can comprise an updater or the above-mentioned monitor procedure, to update the firmware of the touch pad 101. After the transmission of the transmitting sequence is finished, the service may be stopped to release the source of computing.

As above-mentioned, the laptop 100 initiates the monitor procedure to identify whether transmission of the transmitting sequence is finished or interrupted. In one embodiment, the transmission maybe interrupted by at least one of following operations: the laptop 101 is rebooted during updating the firmware, the laptop 101 is shut down during updating the firmware, the laptop 101 enters a sleep mode during updating the firmware, a cover of the laptop 100 is closed during updating the firmware, or an account of the laptop 100 is logged out during updating the firmware.

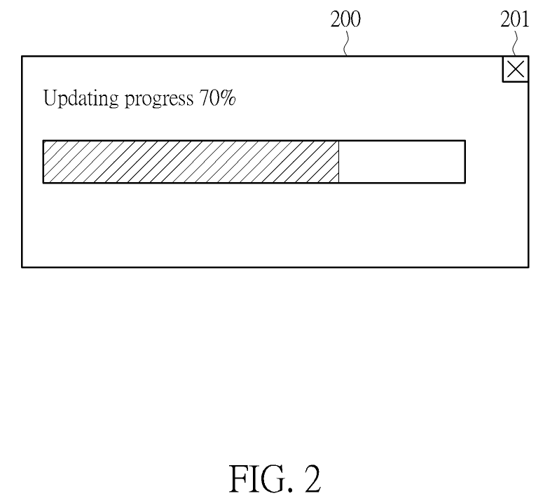

In one embodiment, the transmission of the transmitting sequence is interrupted if the updating is forced to be interrupted. FIG. 2 is a schematic diagram illustrating a progress bar of updating the firmware, according to one embodiment of the present invention. In the embodiment of FIG. 2, a progress bar 200 which represents a progress of updating the firmware is displayed on a display of the laptop 100. The transmission of the transmitting sequence may be interrupted by deactivating the progressing bar 200, for example, a user clicks the X symbol 201 of the progressing bar 200.

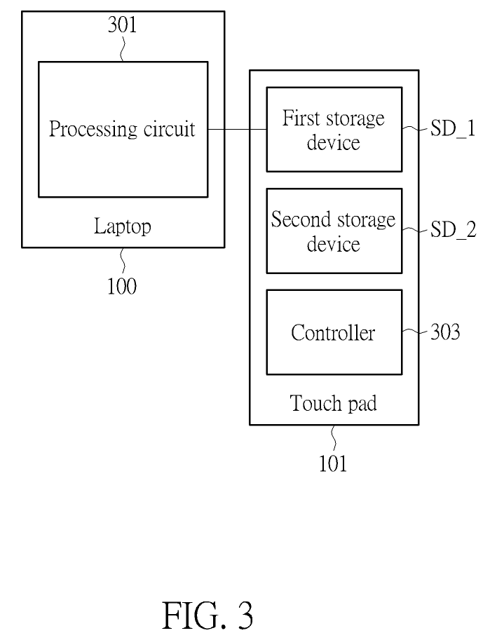

As above-mentioned, the transmission of the transmitting sequence may mean the transmission to a storage device which stores the firmware of the touch pad 101. FIG. 3 is a block diagram illustrating detail operations of updating the firmware, according to one embodiment of the present invention. As shown in FIG. 3, the laptop 100 further comprises a processing circuit 301,which is configured to control the operations of the laptop 100, for example, the processing circuit 301 controls the firmware updating. Also, the touch pad 101 comprises a controller 303, a first storage device SD_1 and a second storage device SD_2. The controller 303 (e.g., a MCU or a control circuit) is configured to control the operations of the touch pad 101.Please note, the first storage device SD_1 and a second storage device SD_2 may also be provided in the laptop 100. In one embodiment, the first storage device SD_1 is a flash memory and the second storage device is a ROM (Read Only Memory) SD_2. Also, the function of the controller 303 may be incorporated into the processing circuit 301.

The controller 303 executes at least one program in the first storage device SD_1 to operate in a first mode. In one embodiment, the laptop 100 receives data of the above-mentioned transmitting sequence in the first mode. Accordingly, the first mode may mean a normal mode in which the laptop 100 does not update the firmware of the touch pad 101 yet and the touch pad 101 operate normally. Also, the controller 303 executes at least one program in the second storage device SD_2 to operate in a second mode. In one embodiment, the laptop 100 updates the firmware in the first storage device SD_1 in the second mode. In other words, the controller 303 does not execute the programs in the first storage device SD_1 while updating the firmware in the first storage device SD_1. Accordingly, in the embodiment of FIG. 3, the above-mentioned transmitting sequence is transmitted to the first storage device SD_1.

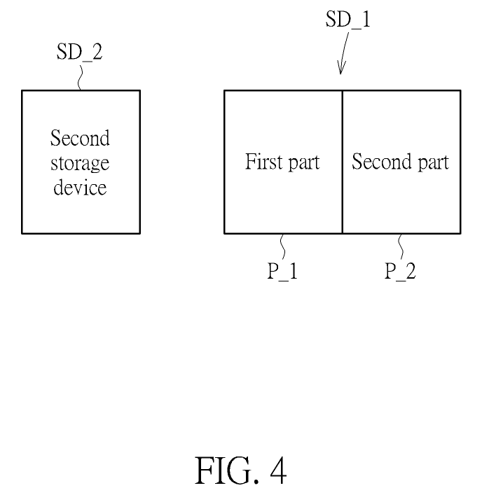

FIG. 4 is a block diagram illustrating the detail structures of the first storage device and the second storage device in FIG. 3, according to one embodiment of the present invention. In the embodiment of FIG. 4, the first storage device SD_1 has a first part P_1 and a second part P_2. The first part P_1 and the second part P_2 may mean the regions with different addresses of the first storage device SD_1. For example, if the first storage device SD_1 is a memory, the first part P_1 and the second part P_2 may mean the regions with different memory addresses.

In the embodiment of FIG. 4, the controller 303 executes at least one program in the first part P_1 of the first storage device SD_1 to operate in the above-mentioned first mode. On the contrary, the controller 303 executes at least one program in the second part P_2 of the first storage device SD_1 to operate in a third mode. In one embodiment, the touch pad 101 reboots in the third mode. In such case, the data stored in the second part P_2 maybe a backup of the data stored in the first part P_1. For example, during updating the firmware in the first part P_1, if the above-mentioned monitor procedure finds that the updating is interrupted, the touch pad 101 may be informed and reboot according to the program in the second part P_2, since the program stored in the first part P_1 may already corrupt.

For more detail, in the embodiment of FIG. 4, while updating the firmware, the controller 303 executes the programs in the second storage device SD_2 to control the touch pad 101. In a conventional firmware updating method, if the updating is interrupted, the controller 103 may not be aware of the interrupting and may still go back to use the program in the first part P_1 to control the touch pad 101. In such case, the touch pad 101 may not operate normally, since the updating of the firmware thereof is not completed. In the present invention, the touch pad 101 may be informed by the monitor procedure that the updating is interrupted, and can operate correspondingly. For example, the touch pad 101 may automatically reboot to recover the program in the first part P_1, or switches to use the program in the second part P_2 to operate, or switches to use the program in the second storage device SD_2 to operate. Also, the laptop 100 may also be informed and re-starts the firmware updating accordingly.

As above-mentioned, the first storage device SD_1 and the second storage device SD_2 may be provided in the laptop 100. In such case, the operations of the touch pad 101 illustrated in FIGS. 3 and 4 may be performed by the laptop 100.

Besides the transmission of the transmitting sequence, other methods can also be used to monitor whether the operation of “updating the firmware” is completed. In one embodiment, the data to be updated (the original data) can be compared to the corresponding data which has been written (the written data) to a storage device storing the firmware (e.g., the above-mentioned first storage device SD_1). If the original data and the written data are the same, it means the operation of “updating the firmware” is completed (succeed). On the contrary, if the original data and the written are different, it means the operation of “updating the firmware” is interrupted (fails). Please note, the original data and the written data mentioned here can mean all of the data to be updated to the firmware, or only a portion of the data to be updated to the firmware.

Also, in another embodiment, the laptop 100 can request the touch pad 101 to provide a version of the firmware. If the version is correct, it means the operation of “updating the firmware” is completed. On the contrary, if the version is incorrect, it means the operation of “updating the firmware” is interrupted. In still another embodiment, the laptop 101 can monitor if the touch pad 101 switches back to use the first storage device SD_1 to operate, since the touch pad 101 uses the second storage device SD_2 to operate while the firmware is being updated.

In still another embodiment, the laptop 100 can acquire the CRC of the data to be updated to determine whether the operation of “updating the firmware” is completed. In still another embodiment, the laptop 100 can determine whether the operation of “updating the firmware” is completed according to a report descriptor, which represents if any function of the touch pad 101 is updated due to the updating of the firmware. In still another embodiment, the laptop 100 can periodically asks the touch pad 101 that if the touch pad 101 operate normally.

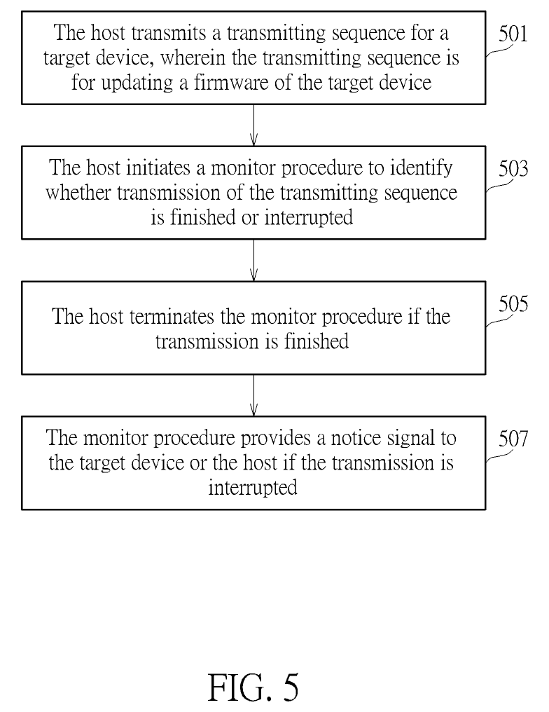

In view of above-mentioned embodiments, a firmware updating method can be acquired. FIG. 5 is a flow chart illustrating a firmware updating method, according to one embodiment of the present invention, which comprises following steps:

### Step 501

The host (e.g., the laptop 100 in FIG. 1) transmits a transmitting sequence for a target device (e.g., the touch pad 101 in FIG. 1), wherein the transmitting sequence is for updating a firmware of the target device.

In one embodiment, the transmitting sequence is transmitted to a storage device comprising the firmware to be updates, such as the first storage device SD_1 in FIG. 3.

### Step 503

The host initiates a monitor procedure to identify whether transmission of the transmitting sequence is finished or interrupted.

### Step 505

The host terminates the monitor procedure if the transmission is finished.

### Step 507

The monitor procedure provides a notice signal to the target device or the host if the transmission is interrupted.

If the host receives the notice signal, it can re-start the firmware updating or using another procedure to inform the touch pad 101.

In above-mentioned embodiments, the firmware updating method is used for updating firmware of the target device. However, the firmware updating method can further be used for updating firmware of sub devices of the target device. The sub devices can be provided inside or outside the target device.

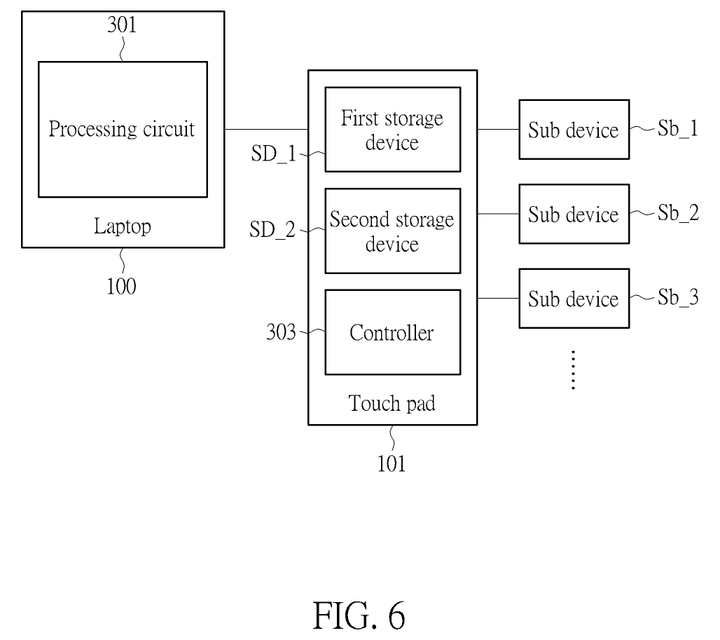

FIG. 6 is a block diagram illustrating a system using the firmware updating method, according to one embodiment of the present invention. The embodiment in FIG. 6 is similar with the embodiment shown in FIG. 3. However, in the embodiment of FIG. 6, several sub devices Sb_1, Sb_2, Sb_3… are connected to the target device 101. Further, in FIG. 6, the firmware updating method is for updating the firmware of the sub devices Sb_1, Sb_2, Sb_3…rather than the firmware of the target device 101. For the convenience of explaining, only the sub device Sb_1 is used as an example for describing.

In one embodiment, the sub device Sb_1 is connected to the touch pad 101 (i.e., an example of a target device) via an interface of the touch pad 101. The interface mentioned here can be any interface which can communicate with the touch pad 101 and the sub device Sb_1. For example, the interface can be a I2C(Inter-Integrated Circuit)interface. Further, the sub device Sb_1 can be any required device. In one embodiment, the sub device Sb_1 is a device which can assist the touch pad 101, such as a vibrator. In another embodiment, the sub device Sb_1 is a device which also has a function related with the touch, such as a fingerprint recognition device.

In FIG. 6, the laptop 100 also comprises a processing circuit 301,which is configured to control the operations of the laptop 100 (i.e., an example of a host), for example, the processing circuit 301 controls the firmware updating. Also, the touch pad 101 also comprises a controller 303, a first storage device SD_1 and a second storage device SD_2. The controller 303 is configured to control the operations of the touch pad 101. Please note, the first storage device SD_1 and a second storage device SD_2 may also be provided in the laptop 100. In one embodiment, the first storage device SD_1 is a flash memory and the second storage device is a ROM (Read Only Memory) SD_2. Also, the function of the controller 303 may be incorporated into the processing circuit 301.

The controller 303 executes at least one program in the first storage device SD_1 to operate in a first mode, which may mean a normal mode in which the laptop 100 does not update the firmware of the sub device Sb_1 yet and the sub device Sb_1 operates normally. Also, the controller 303 executes at least one program in the second storage device SD_2 to operate in a second mode. In one embodiment, the laptop 100 updates the firmware in the first storage device SD_1 in the second mode. In other words, the controller 303 does not execute the programs in the first storage device SD_1 while updating the firmware in the first storage device SD_1. Accordingly, in the embodiment of FIG. 6, the above-mentioned transmitting sequence is transmitted to the first storage device SD_1. Please note, the first storage device SD_1 and the second storage device SD_2 may also be provided in the sub device Sb_1.

As above-mentioned, in FIG. 6, firmware of the sub devices Sb_1, Sb_2, Sb_3…rather than the touch pad 101 are updated. Detail steps of updating the firmware can be acquired in view of the descriptions shown in FIGS. 1-4, thus descriptions thereof are omitted for brevity here.

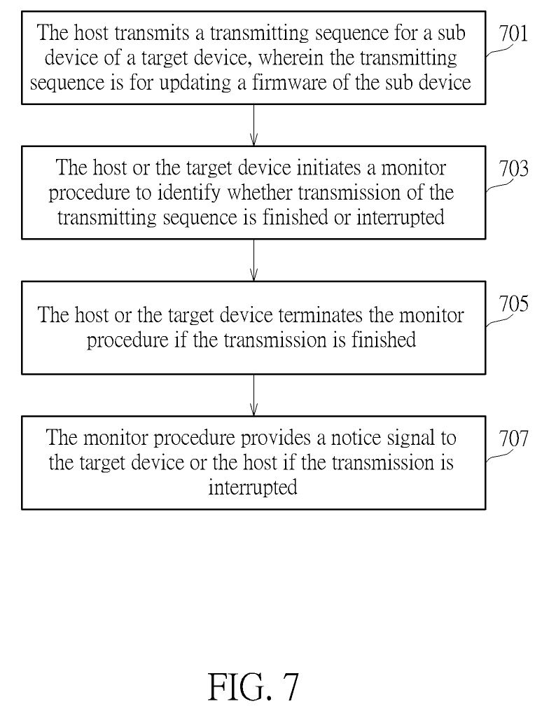

In view of the embodiment shown in FIG. 6, a firmware updating method show in FIG. 7 can be acquired. FIG. 7 is a flow chart illustrating a firmware updating method, according to one embodiment of the present invention. The firmware updating method shown in FIG. 7 comprises following steps:

### Step 701

The host (e.g., the laptop 100 in FIG. 6) transmits a transmitting sequence for a sub device of a target device (e.g., the sub device Sb_1 of the touch pad 101 in FIG. 6), wherein the transmitting sequence is for updating a firmware of the sub device.

In one embodiment, the transmitting sequence is transmitted to a storage device comprising the firmware to be updated, such as the first storage device SD_1 in FIG. 6.

### Step 703

The host or the target device initiates a monitor procedure to identify whether transmission of the transmitting sequence is finished or interrupted.

In the embodiment of FIG. 6, either the host or the target device can initiate the monitor procedure.

### Step 705

The host or the target device terminates the monitor procedure if the transmission is finished.

### Step 707

The monitor procedure provides a notice signal to the target device or the host if the transmission is interrupted.

If the host receives the notice signal, it can re-start the firmware updating or using another procedure to inform the target device. Besides, if the target device receives the notice signal, it can re-start the firmware updating, or using another procedure to inform the host.

In one embodiment, the host or the target device further reads a recorded firmware state to determine if the firmware is successfully updated to sub device. The recorded firmware state is used for representing whether the firmware of a specific device is successfully updated or not. For example, the recorded firmware state is used for representing whether the firmware of the sub device is successfully updated or not. If the recorded firmware state means that the firmware is successfully updated to the sub device, the current firmware updating method may ends. Otherwise, the current firmware updating method may re-start the firmware updating of the sub device. The specific device may be the target device rather than limited to the sub device.

Other methods can also be used to determine if the firmware is successfully updated to sub device. As stated in the descriptions of FIG. 4, the data stored in the second part P_2 maybe a backup of the data stored in the first part P_1. Accordingly, if the program in the second part P_2 is executed rather than the program in the first part P_1 is executed, it may mean the first part P_1 is broken or the firmware is not successfully updated to the first part P_1. In such case, the firmware updating for the first part P_1 can be restarted, to try re-updating the firmware to the first part P_1. Briefly, the firmware updating method provided by the present invention can further determine whether the firmware is successfully updated or not based on which of the first part P_1 and the second part P_2 the target device is executed.

The recorded firmware state can be used in another firmware updating method rather than limited to the firmware updating method shown in FIGS. 6 and 7. Besides the firmware updating method, the present invention further provides embodiments of firmware recovery methods. The firmware recovery method first checks whether the firmware of a specific device is correctly updated. If yes, no changes are made. If not, the firmware updating is restarted again. Accordingly, the firmware recovery method may also regarded as a firmware updating method. The specific device may be the target device or the sub device.

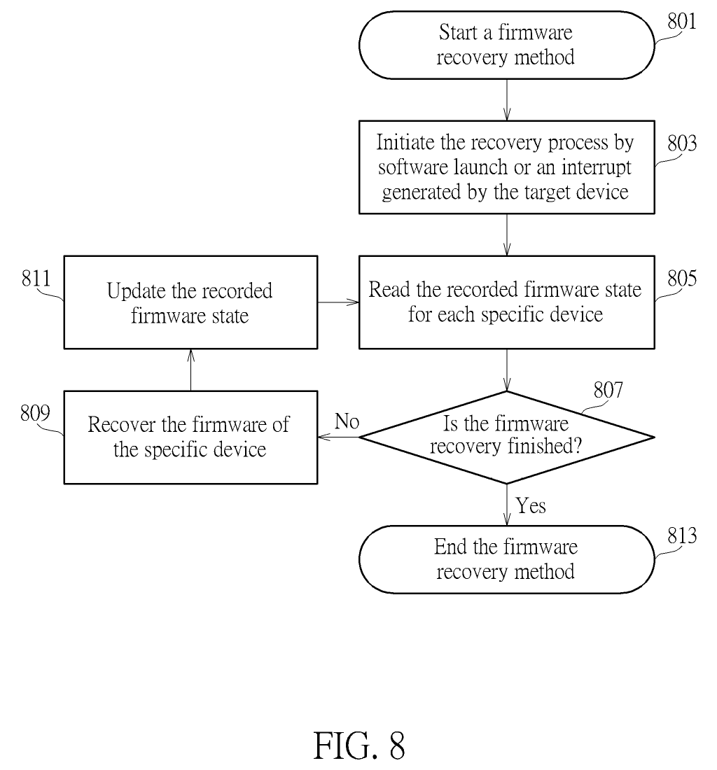

FIGS. 8-12 are flow charts illustrating firmware updating method, according to different embodiments of the present invention.

### Step 801

Start a firmware recovery method.

### Step 803

Initiate the recovery process by software launch or an interrupt generated by the target device.

The software may be installed in the host.

### Step 805

Read the recorded firmware state for each specific device, such as the sub device Sb_1. However, the specific device may also be the target device.

The recorded firmware state may comprise information related with firmware updating, such as: if a previous firmware recovery is succeed, or if the current firmware is a newest version.

The recorded firmware state may be stored in an external storage device of the target device.

### Step 807

Check if the firmware recovery is finished. If yes, go to step 813. If not, go to step 809.

### Step 809

Recover the firmware of the specific device.

For example, the step 809 may re-start the firmware updating of the sub device Sb_1, but not limited.

### Step 811

Update the recorded firmware state.

For example, if the firmware of the sub device Sb_1 is not recovered yet, the recorded firmware state may represent the firmware of the sub device Sb_1 as “not recovered” before the firmware of the sub device Sb_1 is recovered. After the firmware of the sub device Sb_1 is recovered, the recorded firmware state may be changed to represent the firmware of the sub device Sb_1 as “recovery completed”.

### Step 813

End the firmware recovery method.

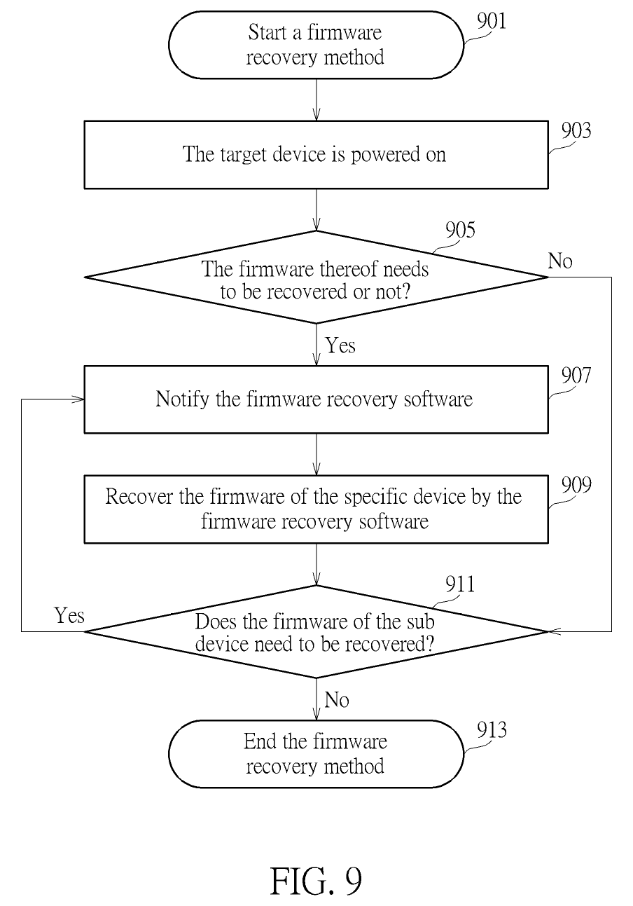

For example, the firmware recovery method in FIG. 9 comprises following steps:

### Step 901

Start a firmware recovery method.

### Step 903

The target device is powered on.

### Step 905

The target device checks whether the firmware thereof needs to be recovered or not. If yes, go to step 907, if not, go to step 911.

For example, the target device checks whether the firmware thereof needs to be recovered or not based on the recorded firmware state.

### Step 907

Notify the firmware recovery software, which may be installed in the host.

### Step 909

Recover the firmware of the specific device by the firmware recovery software.

The specific device may be the target device (corresponding to the step 905) or the sub device (corresponding to the step 911.

### Step 911

The target device checks whether the firmware of the sub device needs to be recovered or not. If yes, go to step 907, if not, go to step 913.

### Step 913

End the firmware recovery method.

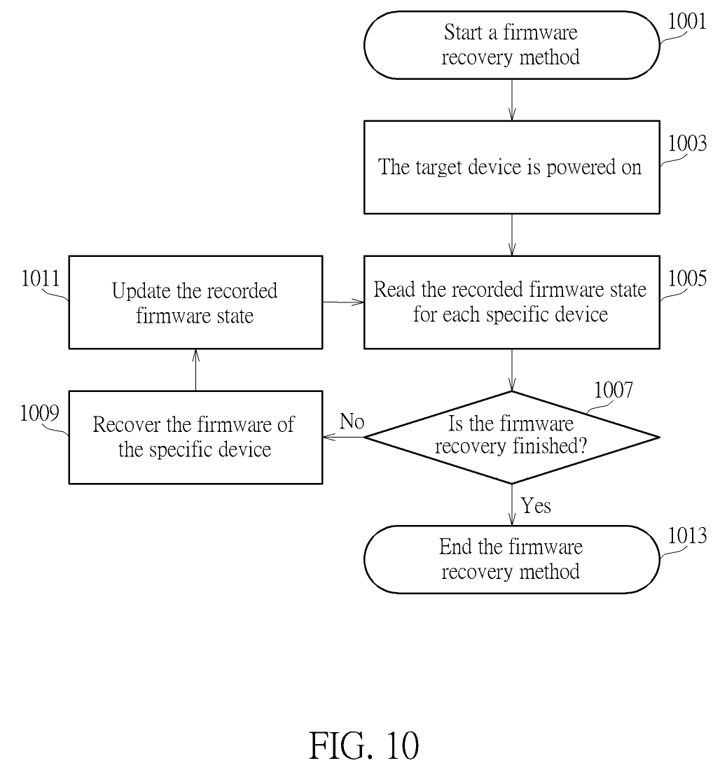

The firmware recovery method in FIG. 10 comprises following steps:

### Step 1001

Start a firmware recovery method.

Step 1003

The target device is powered on.

### Step 1005

Read the recorded firmware state for each specific device, such as the sub device Sb_1. However, the specific device may also be the target device.

In the embodiment of FIG. 8, the recorded firmware state is stored in an external storage device of the target device. However, in the embodiment of FIG. 10, the recorded firmware state is stored in an internal storage device of the target device.

### Step 1007

Check if the firmware recovery is finished. If yes, go to step 1009. IF not, go to step 1013.

Step 1009

Recover the firmware of the specific device.

### Step 1011

Update the recorded firmware state.

### Step 1013

End the firmware recovery method.

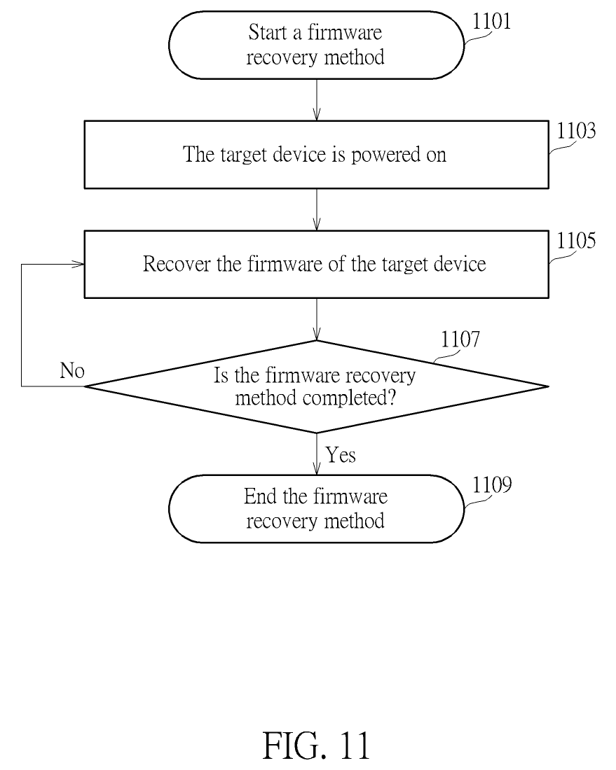

In some embodiments, the sub device may only comprise at least one volatile memory (e.g., a RAM) but does not comprise any non-volatile memory (e.g., a ROM). In such case, if the sub device is powered off, the firmware could not be maintained in the volatile memory. Accordingly, for such example, the firmware recovery shown in FIG. 11 is provided, which comprises following steps:

### Step 1101

Start a firmware recovery method.

### Step 1103

The target device is powered on.

In one embodiment, the firmware updating method shown in FIG. 11 can be performed by software in the host.

### Step 1105

Recover the firmware of the target device.

For more detail, the firmware is read from a storage device in the host. After that, the firmware is updated to a volatile memory in the target device.

It will be appreciated that the target device in steps 1103 and 1105 can be replaced by the sub device.

### Step 1107

Determine if the firmware recovery method is completed. If yes, go to step 1109. If not, go back to step 1105.

For example, check the above-mentioned recorded firmware state to determine if the firmware recovery method is completed.

### Step 1109

End the firmware recovery method.

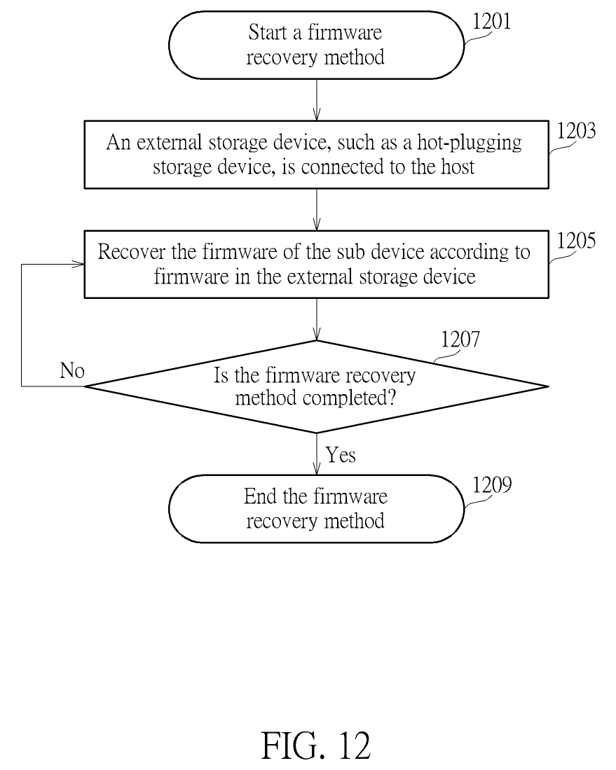

In one embodiment, the firmware to be updated is from an external storage device connected to the host, rather than limited to be from a storage device in the host or the target device. Detail steps are shown in FIG. 12, which comprises following steps:

### Step 1201

Start a firmware recovery method.

### Step 1203

An external storage device, such as a hot-plugging storage device (e.g., a USB flash or a SD card), is connected to the host.

Also, a sub device is powered on.

### Step 1205

Recover the firmware of the sub device according to firmware in the external storage device.

The sub device in the steps 1203 and 1205 can be replaced by a target device.

### Step 1207

Determine if the firmware recovery method is completed. If yes, go to step 1209. If not, go back to step 1205.

### Step 1209

End the firmware recovery method.

In the embodiment of FIG. 12, since the firmware in the external hard disk is used for updating, the firmware of the target device or the sub device can be changed more conveniently and flexibly.

In view of above-mentioned embodiments, the host or the target device can be notified of the firmware update interrupting, and the host or the target device can operate correspondingly. Thus, the issue of the conventional firmware updating method can be improved. Besides, by using the firmware recovery methods provided by the present invention, the firmware of the target device or the sub device may be conveniently recovered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware updating method, applied to a host, comprising:
the host transmitting a transmitting sequence for a sub device of a target device, wherein the transmitting sequence is for updating a firmware of the sub device;
the host or the target device initiating a monitor procedure to identify whether transmission of the transmitting sequence is finished or interrupted;
the host or the target device terminating the monitor procedure if the transmission is finished; and
the monitor procedure providing a notice signal to the target device or the host if the transmission is interrupted.

2. The firmware updating method of claim 1, wherein the sub device is connected to the target device via an interface of the target device.

3. The firmware updating method of claim 1, wherein the target device is a touch pad and the sub device is a vibrator or a fingerprint recognition device`.

4. The firmware updating method of claim 1, wherein the host or the target device further reads a recorded firmware state to determine if the firmware is successfully updated to sub device.

5. The firmware updating method of claim 1, further comprising:
reading the firmware from a storage device in the host; and
updating the firmware to a volatile memory in the target device or in the sub device each time the target device or the sub device is powered on.

6. The firmware updating method of claim 1, wherein the firmware is from an external storage device connected to the host.

7. The firmware updating method of claim 1,
wherein the target device or the sub device comprises a first storage device and a second storage device;
wherein the firmware updating method further comprises:
the target device or the sub device executing at least one program in the first storage device to operate in a first mode; and
the target device or the sub device executing at least one program in the second storage device to operate in a second mode;
wherein the firmware is updated to the first storage device in the second mode.

8. The firmware updating method of claim 7,
wherein the first storage comprises a first part and a second part;
wherein the firmware updating method further comprises:
the target device or the sub device executing at least one program in the first part of the first storage device to operate in the first mode;
wherein the second part backs up at least portion of programs stored in the first part;
wherein the firmware updating method further determines whether the firmware is successfully updated or not based on which of the first part and the second part the target device is executed.

9. An electronic system, comprising:
at least one storage device, configured to store at least one program;
a host;
a target device, comprising at least one sub device;
a processing circuit, configured to execute the program to perform a firmware updating method comprising: following steps:
the host transmitting a transmitting sequence for the sub device of a target device, wherein the transmitting sequence is for updating a firmware of the sub device;
the host or the target device initiating a monitor procedure to identify whether transmission of the transmitting sequence is finished or interrupted;
the host or the target device terminating the monitor procedure if the transmission is finished; and
the monitor procedure providing a notice signal to the target device or the host if the transmission is interrupted.

10. The electronic system of claim 9, wherein the sub device is connected to the target device via an interface of the target device.

11. The electronic system of claim 9, wherein the target device is a touch pad and the sub device is a vibrator or a fingerprint recognition device`.

12. The electronic system of claim 9, wherein the firmware updating method comprises:
the host or the target device further reads a recorded firmware state to determine if the firmware is successfully updated to sub device.

13. The electronic system of claim 9, wherein the firmware updating method comprises:
reading the firmware from a storage device in the host; and
updating the firmware to a volatile memory in the target device or in the sub device each time the target device or the sub device is powered on.

14. The electronic system of claim 9, wherein the firmware is from an external storage device connected to the host.

15. The electronic system of claim 9,
wherein the target device or the sub device comprises a first storage device and a second storage device;
wherein the firmware updating method further comprises:
the target device or the sub device executing at least one program in the first storage device to operate in a first mode; and
the target device or the sub device executing at least one program in the second storage device to operate in a second mode;
wherein the firmware is updated to the first storage device in the second mode.

16. The electronic system of claim 15,
wherein the first storage comprises a first part and a second part;
wherein the firmware updating method further comprises:
the target device or the sub device executing at least one program in the first part of the first storage device to operate in the first mode;
wherein the second part backs up at least portion of programs stored in the first part;
wherein the firmware updating method further determines whether the firmware is successfully updated or not based on which of the first part and the second part the target device is executed.
